(19) United States
(12) Patent Application Publication
(10) Pub. No.: US 2019/0037869 A1
(43) Pub. Date: Feb. 7, 2019

(54) METHOD AND INSTALLATION FOR CONTROLLING AN ATMOSPHERE IN A SPACE WHICH IS AT LEAST PARTIALLY FILLED WITH AGRICULTURAL OR HORTICULTURAL PRODUCTS

(71) Applicants: ENVIRONMENTAL MONITORING SYSTEMS (EMS) B.V., Sint-Annaland (NL); STOREX B.V., 's-Gravendeel (NL)

(72) Inventors: Jan-Kees BOERMAN, Sint-Annaland (NL); Peter Anthon Cornelis KOOIJMAN, Hendrik-Ido-Ambacht (NL)

(21) Appl. No.: 16/075,096

(22) PCT Filed: Feb. 3, 2017
(86) PCT No.: PCT/EP2017/052478

§ 371 Date: Aug. 2, 2018

(30) Foreign Application Priority Data
Feb. 3, 2016 (EP) PCT/EP2016/052319

(51) Int. Cl. A23B 7/148; A23B 7/152; A23L 3/3409; A23L 3/3418

(52) U.S. Cl. CPC A23B 7/148; A23L 3/3418; A23L 3/34095; A23B 7/152

(57) ABSTRACT

A method for controlling an atmosphere in a space which is at least partially filled with agricultural or horticultural products comprises the steps of (a) measuring an amount of at least one metabolite such as acetaldehyde, ethyl acetate and/or ethanol produced by the products, (b) measuring at least one of (i) an amount of oxygen absorbed by the products and (ii) an amount of carbon dioxide produced by the products, (c) determining a relationship between the measured amount of the metabolite and the measured amount of oxygen and/or carbon dioxide, (d) analyzing the determined relationship to detect a potential onset of fermentation in the products and (e) selectively adjusting a level of at least one component of the atmosphere in the space on the basis of the analysis. An installation for carrying out this method is also claimed.

### FIELD OF THE INVENTION

The invention relates to a method and an installation for controlling an atmosphere in a space which is at least partially filled with agricultural or horticultural products. Such methods and installations are well known, and are generally used for long term storage of fresh agricultural products like fruit. However, such methods and installations may also be used when storing other fresh, perishable horticulture, agriculture or natural products (for example food like vegetables, fruit, fish, meat, dairy products, cereals, fats, drinks, liquids, plants and flowers) or food.

### BACKGROUND OF THE INVENTION

Fruit is picked in the late summer or beginning of the autumn. From this moment fruit is chemically treated and/or stored in postharvest conditions to be available to the market all year round. In fruit storages it is always important to know the status of the fruit during this long storage period. This means that owners of the fruit want to know what the best storage conditions are for the fruit. The art of storage is to keep the fruit in the storage for as long as possible with a minimum loss of quality. One of the most important parameters, besides temperature and relative humidity in the storage is oxygen. By lowering the oxygen concentration the respiration of the fruit can be reduced. Reduction of respiration results in a longer storage period, maintaining quality over time. From research in the last years much is known about the relationship between the oxygen concentration and the quality of the fruit during the storage period. Especially for apples there is very much knowledge. By lowering the oxygen concentration as far as possible, some typical and well-known fruit diseases may be prevented during the storage period. Another advantage is that by maintaining optimum oxygen levels it is possible to exclude some chemical treatments. So a green alternative is available.

The present invention is specifically aimed at fruit which has to be stored for a longer period of time. For example for apples such a longer period will typically be 3-9 months. For other types of fruits or fresh, perishable products this period can vary. After harvesting the fruit the natural process of growing by photosynthesis is abruptly stopped and the process of assimilation of sugars starts in the fruit. In case of an excess amount of oxygen, the assimilation of sugars is typically summarized in the known chemical formula:

C₆H₁₂O₆+6O₂→6CO₂+6H₂O+volatiles+energy (1)

or in words:

sugar+oxygen→carbon dioxide+water+volatiles like ethylene, aromatics, etc.+energy

Products like apples are stored in so-called Controlled Atmosphere (CA) or Ultra Low Oxygen (ULO) cold storages. These storages are constructed gastight and are connected with control systems like cooling systems, control devices for removal and control of the oxygen and/or carbon dioxide level. The quality of the stored product (for instance apples) will be improved when the oxygen level is reduced to a level between 1-2% oxygen while the level of carbon dioxide is kept at a level of typically 1-2%. Also for volatiles like ethylene the level of presence can be controlled.

From previous research it is well known that the optimum oxygen concentration for apples inside a storage can be optimized by finding the point at which a very small amount of ethanol inside the apple is produced while pulling down the oxygen concentration inside the storage over time. This point of change of the process from an aerobic to an anaerobic process is the fermentation process.

C₆H₁₂O₆→2C₂H₅OH+2CO₂+volatiles+energy (2)

or:

sugar→ethanol+carbon dioxide+volatiles like ethylene, aromatics, etc.+energy

This process inside apples acts as a fruit response signal in which both an increase of carbon dioxide and ethanol is produced. Ethanol inside the fruit flesh is then released from the fruit and turns into the gas phase. The production of ethanol inside the fruit is reversible when the oxygen amount is increased and the amount of ethanol is not too high. When during the fermentation process the oxygen is increased, the fruit will convert the ethanol inside back to sugars. This process is the so-called re-metabolism process which allows apples to convert ethanol from sugars when there is a shortage of oxygen and vice versa when ethanol is inside the fruit and an excess of oxygen is available.

The optimum oxygen concentration is the concentration that is as low as possible but without the situation that fruit will deteriorate by fermentation. When the oxygen concentration is gradually reduced towards the concentration of 0% oxygen, the fruit will reach the state in its decreased metabolism. The conversion of sugars to respiration will be reduced until the fermentation starts. Ethanol is formed in the fruit which changes the structure, color, smell and taste. The longer the fermentation takes place, the stronger these effects are. In the end the fruit will rot. From previous research it is well known that the preservation of quality can be optimized by finding the lowest level of oxygen at which ethanol is nearly not produced in a fruit storage.

There are currently five methods to control the optimum oxygen concentration in a space.

A first method is called ‘harvest watch’ and is described in “The harvest watch system—measuring fruits healthy glow”, B. E. Stephens and D. J. Tanner, ISHS Acta Horticulturae 687: International Conference Postharvest Unlimited Downunder 2004. This system is based on an optical measurement of fluorescence of the chlorophyll in the peel. This fluorescence is an indicator related to chlorophyll. The method is based on illumination of a fruit sample and deriving the risk of fermentation from the measured fluorescence. Under influence of certain stress factors the rate of chlorophyll fluorescence can vary and be measured. The problem with this system is that fluorescence of the products (in this case used for apples) is strongly dependent on other factors. Based on tests carried out and reports based on practical experience the relation between a low oxygen level at or below the oxygen level where fermentation starts and the response of the chlorophyll fluorescence sensor, it turned out that the correlation is not reliable and that there is no scientific evidence of the correlation between the direct fermentation and the fluorescence/chlorophyll change. This means that unwanted measurement error can occur easily.

Prior art document US2013/013099 A1 discloses a method based on the determination of a parameter called GERQ which predicts fermentation based on a calculation of the emission of the carbon dioxide (CO₂) divided by the uptake from the fruit of the oxygen (O₂) of the fruit while continuously supplying oxygen to overcome the possible leakage of a storage space. This method is particularly useful under laboratory circumstances and up to now it is not known to be used in practice storage spaces. A drawback of the system is that there are many influencing factors that must be considered.

In prior art document WO 2013/125944 A1 a control system for storages is disclosed which is based on the determination of the transition from respiration to fermentation by the periodic measurement of the respiration coefficient RQ in a storage space. The respiration coefficient is a calculation based on the emission by the fruit of carbon dioxide (CO₂) divided by the uptake of oxygen (O₂) from the fruit while periodically closing the complete storage and shutting down all the processes around the storage space for several hours. The disadvantage of this system is that the respiration coefficient is an indirect derivation of the fermentation that took place in the fresh product. Another problem is that RQ control on a large variety of cultivars is very risky. The O₂ consumption and the CO₂ production is not the same for the existing cultivars. One variety may have a different RQ than another variety. The fermentation which also occurs with the rise of the RQ may be uncontrolled and undetermined.

Another control system close to the former system is disclosed in US2014/242225 A1. In this prior art document a mathematical model is used for determining the actual respiratory and fermentative rates based also on the respiration coefficient RQ. The determination of the respiration coefficient is also done in basis by a calculation of the emission by the fruit of carbon dioxide (CO₂) divided by the uptake of oxygen (O₂) from the fruit. The measurements are done in a separate measurement box inside a storage space which is representative for the entire storage. In this system the limitation is also that the RQ is a derivation which pretends to predict the fermentation.

Another prior art way to determine the optimum oxygen concentration in the storage is the use of the DCS protocol (Dynamic Control System). This system, which is disclosed in WO 96/18306, controls the oxygen level in a CA storage based on an absolute volume of ethanol which is measured. This ethanol is produced as a result of a fermentation process in the atmosphere inside a CA room or storage space. Although the document discloses measuring the amount of ethanol in the storage by a sensor and continuously using this measurement for controlling the oxygen supply to the storage, in actual practice the determination of ethanol inside apples is done by several other types of measurement. Samples are picked from the storage and the amount of dissolved ethanol is determined in pulp by LC, LCMS or colorimetric/fluorometric assay kits or spectrometer analyzers. Electrochemical sensors were developed, but were not reliable enough to measure the ethanol.

From all these prior art documents it is known that the fruit quality is preserved in the best way at oxygen levels on or just above threshold level at which fermentation starts. The advantages of storing fruits at such low oxygen levels are: a minimum level of respiration, prevention of storage diseases like scald and internal browning, improved preservation of firmness, improved appearance and a better shelf life.
The present invention is aimed at providing an improved method for controlling the atmosphere in a space, in particular a CA or ULO storage, in which the drawbacks of the prior art are wholly or partially obviated. In accordance with the invention, this is achieved by a method comprising the steps of:
a) measuring an amount of at least one metabolite such as acetaldehyde, ethyl acetate and/or ethanol produced by the products;
b) measuring at least one of:
   i) an amount of oxygen absorbed by the products; and
   ii) an amount of carbon dioxide produced by the products;
c) determining a relationship between the measured amount of the metabolite and the measured amount of oxygen and/or carbon dioxide;
d) analyzing the determined relationship to detect a potential onset of fermentation in the products; and
e) selectively adjusting a level of at least one component of the atmosphere in the space on the basis of the analysis.

The invention is based on the insight that the true and one-and-only markers and markers of importance for the determination of fermentation are the metabolites, in particular ethanol. The fermentation process is well known for fresh, perishable horticulture, agriculture or natural products (for example food like vegetables, fruit, fish, meat, dairy products, cereals, fats, drinks, liquids, plants and flowers) or food. The process happens even in the human body. The process is an ethanolic fermentation pathway.

Ethanolic fermentation is a major pathway induced in plant tissues in response to very low O₂ and/or very high CO₂ concentrations. In this pathway, acetaldehyde is produced through pyruvate decarboxylation catalyzed by PDC. The enzyme ADH reduces acetaldehyde into ethanol using NADH. Ethanol is usually the major product of the pathway in low O₂-stressed fruit (Ke and Kader, 1992; Ke et al., 1991b).

However, rather than taking the absolute value of the ethanol measurement as parameter, the present invention recognizes that it is the relationship between the ethanol production and either the oxygen uptake or the carbon dioxide production which provides an early indication of impending fermentation. This early indication allows an improved control of the atmosphere within the space.

The step of analyzing the determined relationship may include analyzing a graphical representation of the relationship.

The analysis of the determined relationship may further serve to detect a potential onset of rot or decay of the products.

In a first embodiment of the invention the relationship is determined from a lookup table.

In another embodiment the relationship is determined by dividing the measured amount of the metabolite by the measured amount of oxygen or the measured amount of carbon dioxide to establish a fermentation quotient. This fermentation quotient is a clear and early indicator of the start of the fermentation process.

Preferably the level of the at least one atmospheric component is adjusted when the fermentation quotient exceeds a predetermined threshold.

In an embodiment of the invention a sample is taken from the products in the space, and the measured amount of the metabolite and the measured amount of oxygen and/or carbon dioxide represents the metabolite produced by the products in the sample and oxygen absorbed or carbon dioxide produced by the sample products, respectively. In this way the fermentation can be controlled on the basis of only a small number of products, so that the risk of damaging the entire contents of the space is limited.

A very precise measurement of the ethanol content can be obtained when the sample products are isolated from the rest of the products in the space and when an atmosphere surrounding the isolated sample products is stripped of other volatiles at least before the amount of the metabolite is measured. This may be done with relatively simple means when the atmosphere surrounding the isolated sample products is filtered before the amount of the metabolite is measured.

In one embodiment of the invention the atmosphere surrounding the isolated sample products is first brought into communication with the atmosphere in the space, is then isolated from the atmosphere in the space, is subsequently pressurized to test for potential leakage between the isolated atmosphere and the atmosphere in the space, and is then stripped of the other volatiles before measurement of the amount of the metabolite, and wherein after the measurement the atmosphere surrounding the isolated sample products is again brought into communication with the atmosphere in the space. This order of carrying out the various steps is efficient and yields good results.

In order to achieve a reliable and stable measurement the actual amount of the metabolite and the actual amount of oxygen and/or carbon dioxide may be repeatedly measured and production rates of the metabolite and oxygen and/or carbon dioxide, respectively, may be determined on the basis of successive measurements.

In a preferred embodiment the metabolite is ethanol and the amount of the metabolite is measured by an ethanol sensor which is calibrated before each measurement. This repeated calibration prevents zero drift and provides a very precise measurement. In that respect it should be noted that the amount of ethanol that is released by the products is so small that the ethanol concentration in the space will typically be in the order of several hundred parts per billion (ppb), while the other components of the atmosphere in the space are measured in parts per million (ppm), i.e. several orders of magnitude larger.

Therefore, it is preferred that the ethanol sensor is calibrated by performing a measurement of a part of the atmosphere that is devoid of ethanol.

In another embodiment of the invention step b-ii) comprises measuring both an amount of carbon dioxide produced by the isolated products and an amount of carbon dioxide produced by the products in the space, and the measured amount of carbon dioxide in the space is analyzed independently to detect a potential onset of fermentation and/or rot or decay of the products. In this way an additional or alternative marker is provided for triggering the control of the oxygen supply.

The invention further provides an installation with which the above-defined method can be performed. In accordance with the invention, such an installation comprises:
a) first measuring means arranged for measuring an amount of at least one metabolite such as acetaldehyde, ethyl acetate and/or ethanol produced by the products;
b) second measuring means arranged for measuring at least one of:
   i) an amount of oxygen absorbed by the products; and
   ii) an amount of carbon dioxide produced by the products;
c) determining means arranged for determining a relationship between the measured amount of the metabolite and the measured amount of oxygen and/or carbon dioxide;
d) analyzing means arranged for analyzing the determined relationship to detect a potential onset of fermentation in the products; and
e) adjustment means arranged for selectively adjusting a level of at least one component of the atmosphere in the space on the basis of the analysis.

Preferred embodiments of the installation form the subject matter of dependent claims 15-30.

And finally, the invention provides an isolated chamber and an ethonal sensor for use in the installation as defined above.

The invention is now illustrated by an exemplary embodiment, with reference being made to the annexed drawings, in which:

FIG. 1 is a schematic front view of walls of adjacent storage spaces which are provided with test chambers for isolating samples of products on which control of the atmosphere in the storage spaces is to be based;

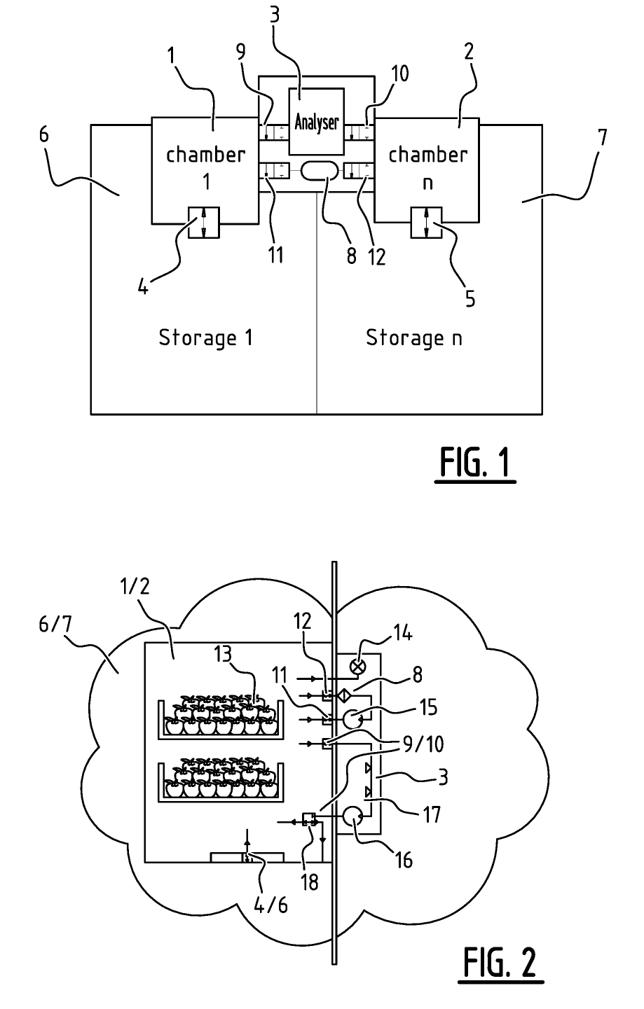

FIG. 2 is a schematic side view of a test chamber filled with a sample of the products, showing the elements of the control system;

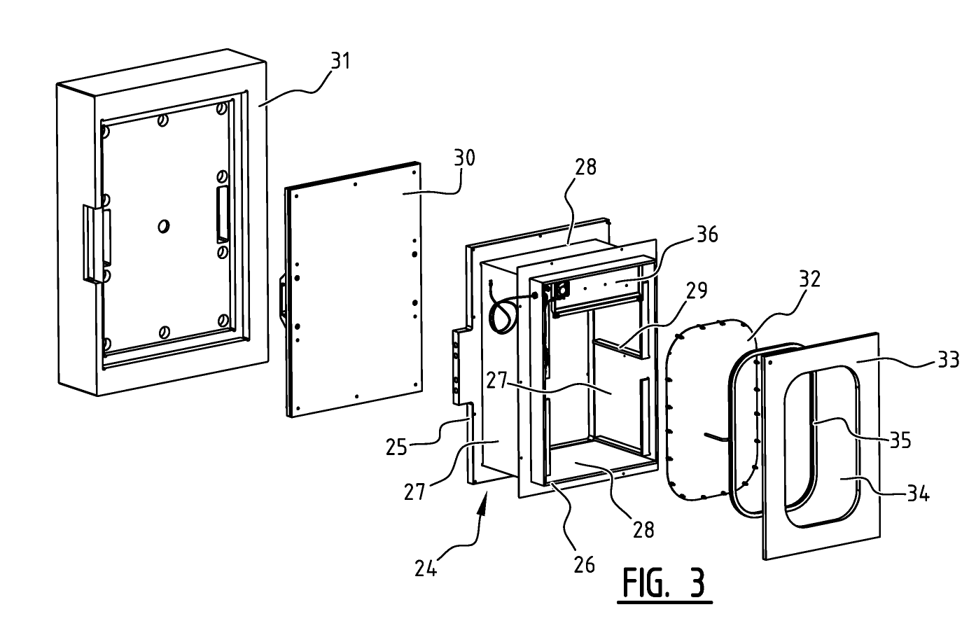

FIG. 3 is an exploded view of an actual embodiment of the test chamber;

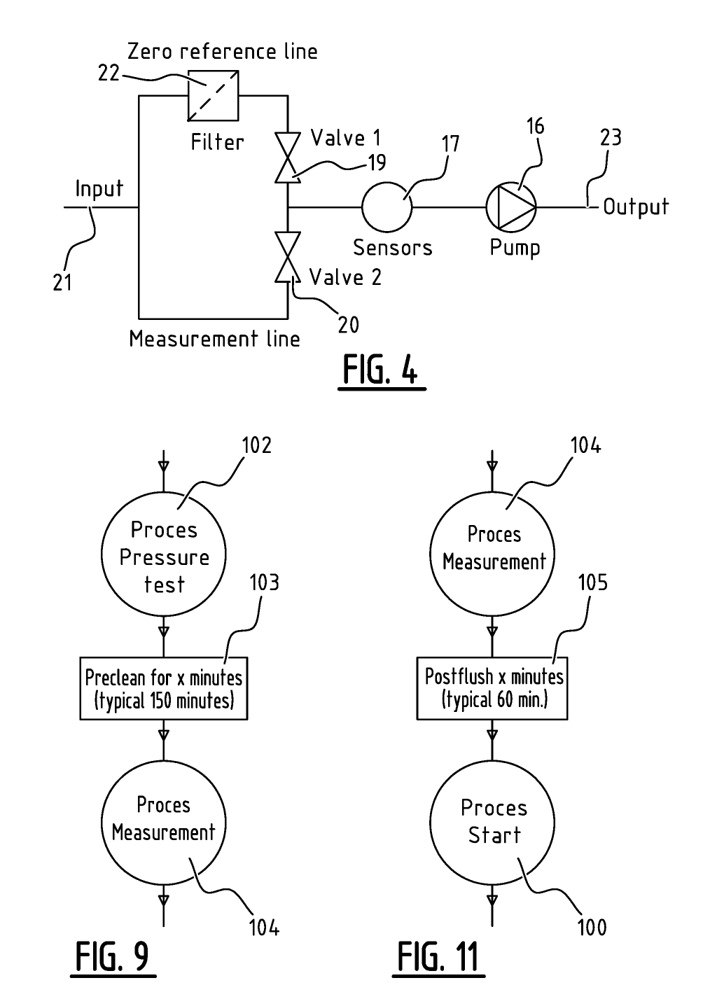

FIG. 4 is a schematic representation of an ethanol sensor for use in the control system;

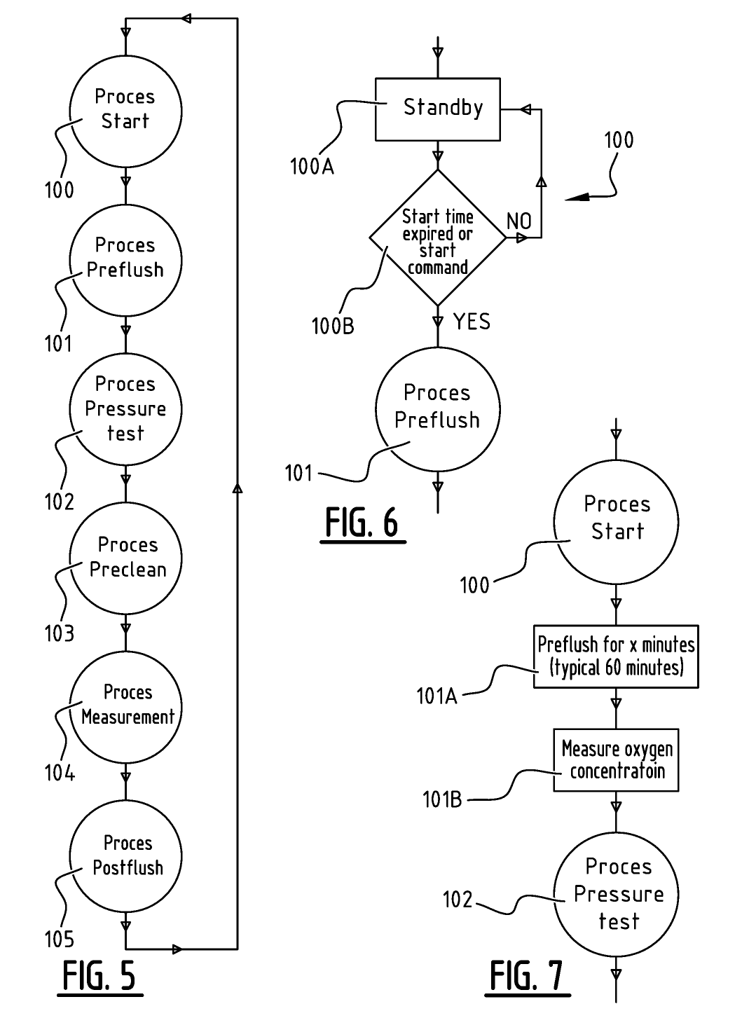

FIG. 5 is a general flow diagram of an embodiment of the method for measuring production of a metabolite and oxygen consumption and/or carbon dioxide production;

FIG. 6 is a detailed flow diagram of the start phase of the method of FIG. 5;

FIG. 7 is a detailed flow diagram of the pre-flush phase of the method of FIG. 5;

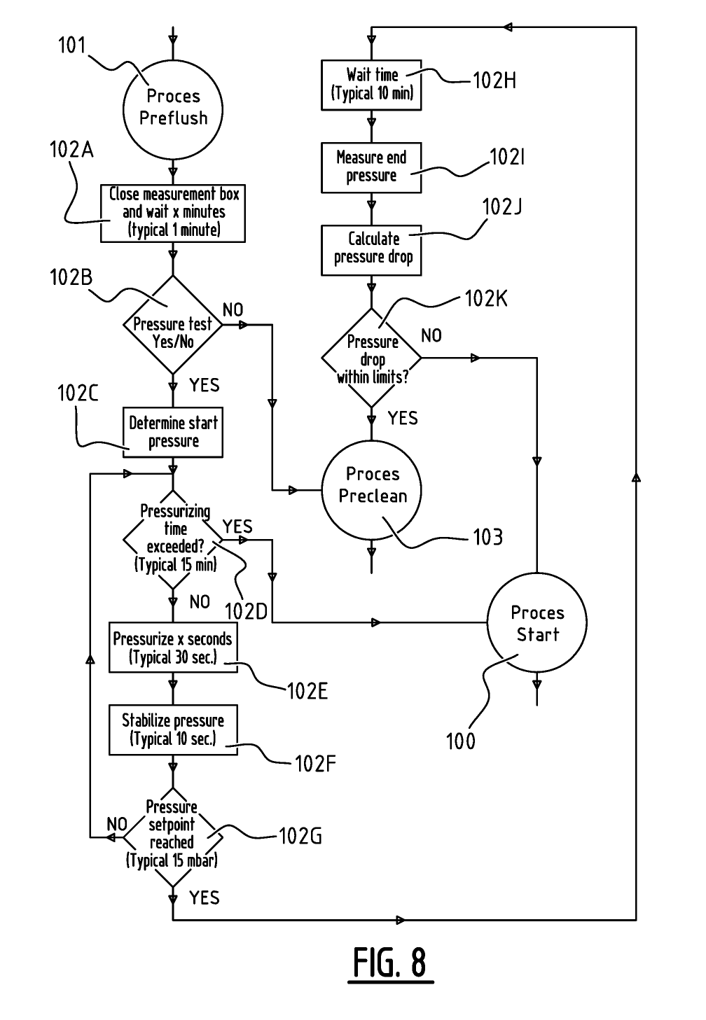

FIG. 8 is a detailed flow diagram of the pressure test phase of the method of FIG. 5;

FIG. 9 is a detailed flow diagram of the pre-clean phase of the method of FIG. 5;

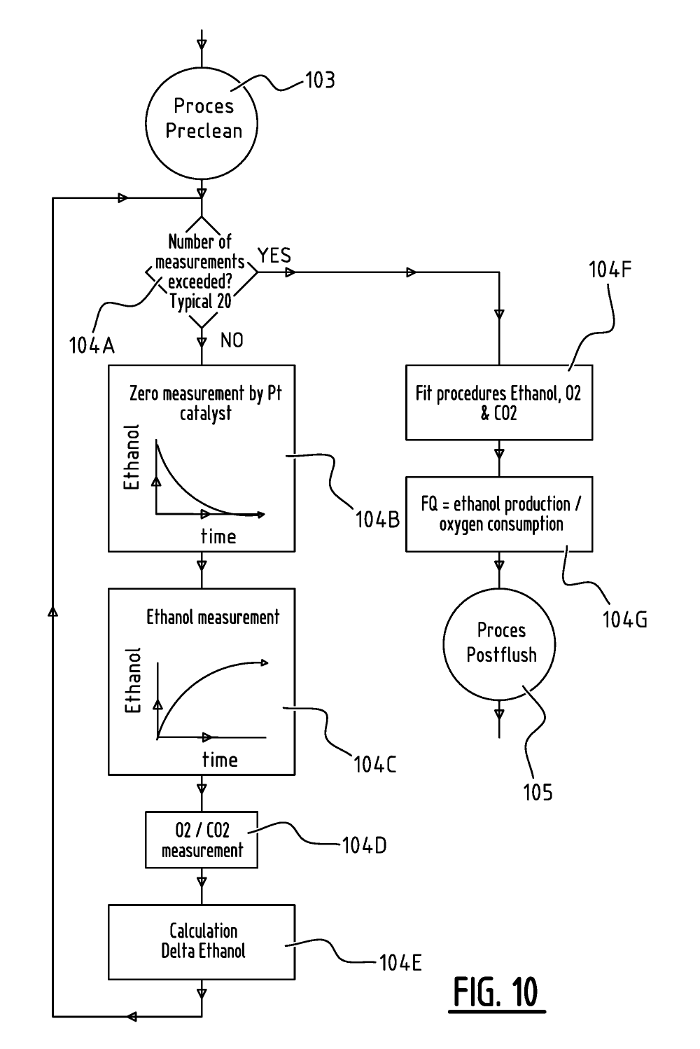

FIG. 10 is a detailed flow diagram of the measurement phase of the method of FIG. 5;

FIG. 11 is a detailed flow diagram of the post-flush phase of the method of FIG. 5;

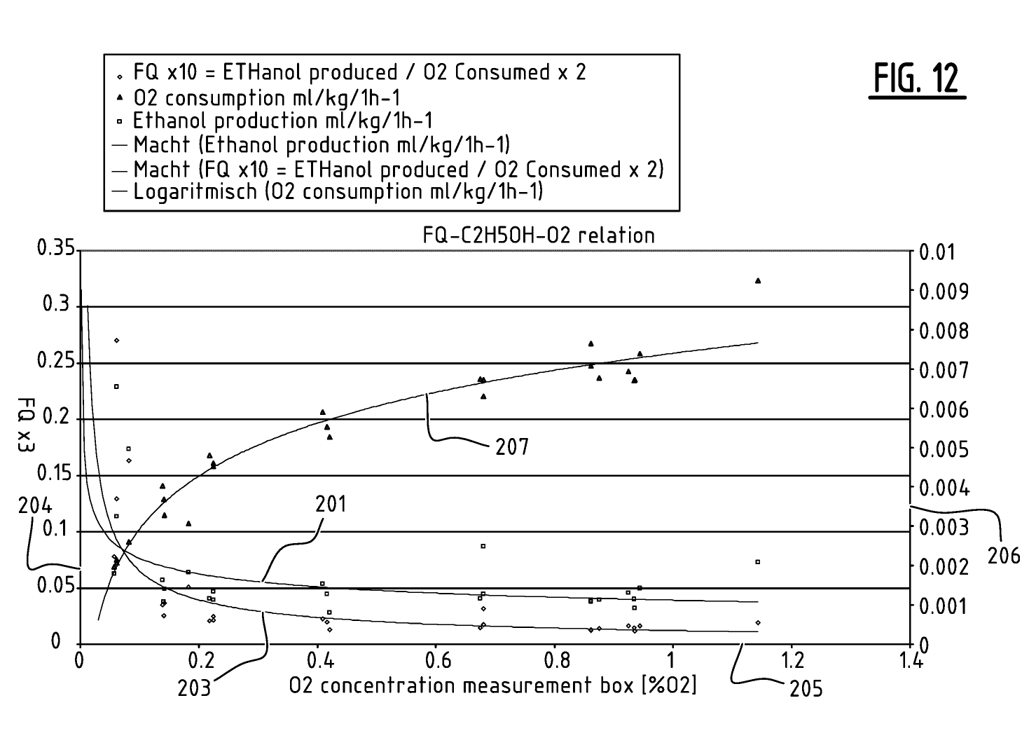

FIG. 12 is a graph showing the relationship between ethanol production, oxygen consumption and fermentation quotient;

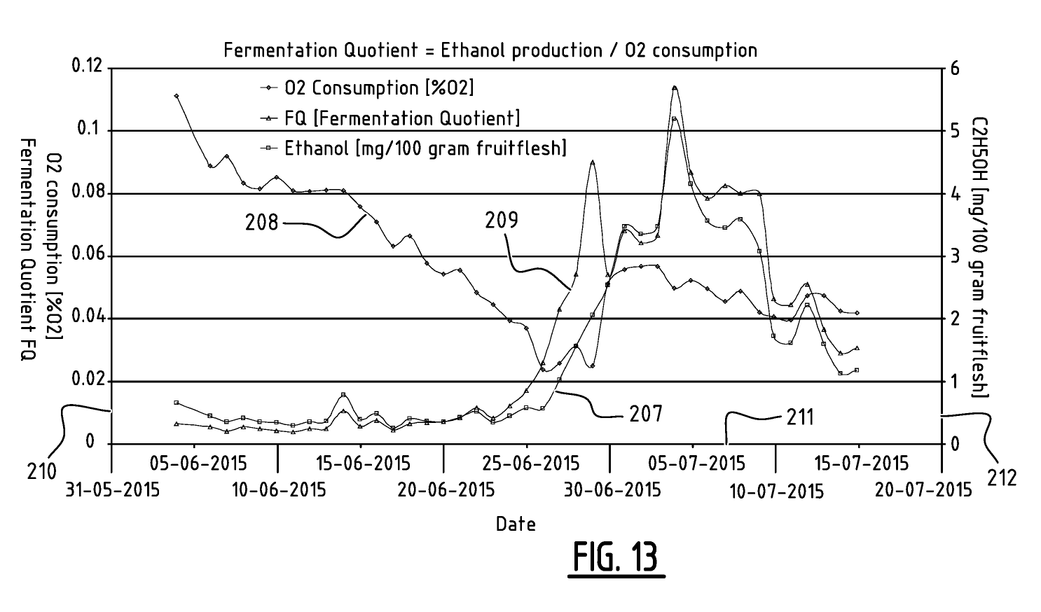

FIG. 13 is a graph showing the development of ethanol production, oxygen consumption and fermentation quotient over time; and

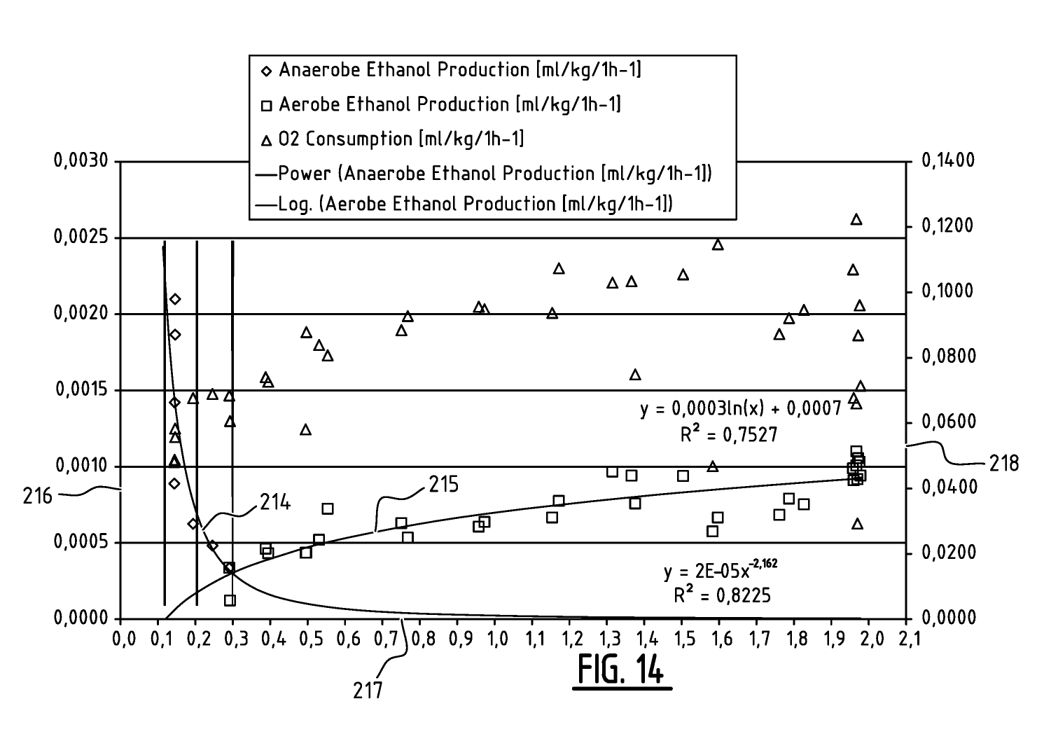

FIG. 14 is a graph showing the relationship between ethanol production and oxygen concentration.

The system or installation of the invention comprises of a controlled atmosphere storage 6, 7 in or at which one or more test chambers 1, 2 are placed (FIG. 1). In the test chamber(s) 6, 7 the sampled product 13 is placed. The storages 6, 7 can exchange air by a room valve connection 4, 5 which can be opened or closed. Each test chamber 1, 2 is directly connected with an analyser 3 which analyses the gas composition using an analysis system and/or gas sensors 17 that is placed inside. The air flowing through the gas sensors 17 is circulated or drawn in by a pump 16. This part of the analyser 3 is connected to the test chambers 1, 2 by connections 9, 10 that can be opened or closed. The system further comprises a filter 8 which cleans the gas composition in the test chambers 1, 2 from unwanted volatile organic or aromatic compounds. The flow through the filter 8 is regulated by a pump 15 that is connected in the gas stream of the filter. The filter 8 can be connected to or disconnected from the test chambers 1, 2 by the valves with connections 11, 12 which can be opened or closed. The system further comprises a pressure sensor 14 that measures the under- or overpressure in the system. The test chambers and the storages are not restricted to a number of two, but can be any number.

Each test chamber 1, 2 can include a rectangular frame 24 having a front face 25 and a rear face 26 (FIG. 3). The frame 24 has two long sidewalls 27 and two short sidewalls 28. Two crate support members 29 are arranged over each other inside the frame 24. The front face 25 may be closed of by a cover 30 and a cover isolation block 31. The rear face 26 may be closed off by a bottom plate 33 having a central opening 34. The central opening 34 in turn is closed of by a clamping plate 32 and an inflatable gasket 35 arranged between the clamping plate 32 and the bottom plate 32 and surrounding the central opening 34.

The test chamber can be used in two ways.
1. In the first way the test chamber(s) 1,2 are mounted in direct connection with a storage 6, 7, (for example a fruit storage, but not only strictly a fruit storage). In the test chamber products (for example fruit, but not only strictly necessary fruit) are placed in a certain determined and predefined mass. The test chamber is covered and closed by placing the lid or cover and the product is from this end gas tight completely isolated. The climate is regulated inside the test chamber by the main storage that is directly connected to the test chamber by means of 1 or more room valve connections 4, 5 that can be opened or closed. The temperature is determined by the energy transfer between the test chamber and the storage as well the gas concentrations inside the test chamber are determined by the storage due to gas exchange between the test chamber and the storage by means of automatic opening and closing the room valve connection. Instead of a valve also an inflatable seal may be used, which may be arranged along the edge of a transparent cover.
2. In the second way the test chamber is used as stand-alone test chamber, for example in a laboratory to simulate storage conditions. Regarding the temperature, the storage conditions are then determined by external equipment like cooling and heating equipment that controls the temperature inside the chamber. The gas concentrations are regulated by external gas flow lines that are connected to the test chamber. These gas flow lines containing gasses like air, oxygen, nitrogen, ethylene, ethanol or any other gas control the gas composition inside the test chamber.

The analyser 3 is connected by connections with the test chamber(s) 9, 10 which can be opened or closed. The analyser comprises sensors or analysis apparatus which are able to measure the gas composition. Gas types that are analysed are: oxygen, ethanol and ethylene (strictly necessary) as well as carbon dioxide and other possible gasses that are required.

As stated above, the system further comprises a filter unit 8 that is installed and is connected by connections 11, 12 that can be opened or closed.

The analyser 3 is based on an ethanol sensor (FIG. 4).This ethanol sensor is arranged to be calibrated between measurements. The calibration is done by performing a measurement of a gas sample that is stripped of all ethanol, and then performing a similar measurement of a complete gas sample. The difference between these two measurements will be a very good representation of the amount of ethanol. The ethanol is stripped from the gas sample by a catalytic converter. The catalyst is only able to remove ethanol and thus creates a stable baseline measurement which acts as a reference which determines strongly the accuracy of the system. With this reference it is even possible to measure in high ethylene producing apples like the cultivar Jonagold that produces up to 200 ppm of ethylene which is a 1000 fold more then the ethanol concentration that must be detected. The signal of ethanol is superposed on the existing interference signals that consist of ethylene and many other organic compounds.

The process of the catalytic conversion of ethanol on Pt loaded Al2O3 adsorbs ethanol on active platinum sites which results in different possible reaction paths as an oxidation reaction to ethanal (acetaldehyde) and water converting to ethanoic acid (acetic acid) or ethanol oxidation will convert to water and CO2 or ethyl acetate. At 1% loading of Pt on Al2/O3 it is accepted that ethanol is converted to CO2 and water. At 2% loading of Pt on Al2O3 it is accepted that ethanol is converted to ethyl acetate. At 3% loading of Pt on Al2O3 it is accepted that ethanol is converted to ethyl acetate or CO2.

The advantage of this method of ambient catalytic ethanol conversion is that this method can be used without changing the gas composition. In traditional (chemical) filters or traditional heated catalyst, the gas composition is always changed in a negative way by an unbalance of temperature changes and/or humidity changes.

Description of Catalyst with Sensors:

FIG. 4 shows an alternative embodiment of the gas sensor arrangement of the analyser 3. It includes two valves 19, 20, one of which is active or open while the other is inactive or closed. These valves 19, 20 could be combined into a single 3-way valve. In this description the pump 16 is always running and drawing a continuous flow. The flow will then flow either across valve 19 or across valve 20. When the measurement starts the process always starts with the zero phase, at which the valve 19 is switched on and valve 20 is switched off. Air from measurement box is then flowing into the “input” 21. The air passes the Pt-catalyst 22 followed by valve 19 to the sensor 17, and is pumped to the output 23 by the pump 16. In this phase all the air coming from the measurement box passes the catalyst. The catalyst will absorb, convert and desorb the compounds or molecules of interest. In this process ethanol is converted to several species depending of working temperature and percentage loading of the noble material. All other compounds (Gas_Interference_z) will pass the catalyst substantially without changing the composition of the air from the measurement box. In this situation the sensor reacts also on all other possible interferences and gives a signal. The interference signals are seen as unwanted signals for the sensor, and are of no interest for the end-result.

The signal resulting from the catalyst conversion is called Sz, indicating the “Sensor zero” reference that is created which is in practice nearly zero ethanol due to the catalytic conversion. This zero phase is kept for x minutes, which can be adjusted, typically but not strictly necessary 6 minutes. At the end of this zero phase the results of the measurement Sz are stored. Not strictly necessary but improving the quality, fit analysis and mathematical extrapolation routines are used to predict longer measurement times longer than x minutes. Due to the unique conversion of ethanol that takes place at ambient temperatures, the relative humidity (RH) and temperature influences on the sensor are excluded and rejected. The signal that causes an influence on the sensor caused by the relative humidity in the zero phase is called RH_z. The signal that causes an influence on the sensor caused by the temperature in the zero phase is called T_z. There is no change of the gas composition due to temperature changes when the gas passes the Pt-catalyst. Due to the isothermal character of the catalyst also the water expressed in relative humidity is not changed. The gas composition and the resulting signal Sz results in all gasses available in the measurement box excluding ethanol.

After the zero phase has taken place for y minutes, valve 19 is switched off and simultaneously valve 20 is switched on. This results in flow that is flowing into input 21 and is flowing through valve 20 to the sensor 17 and is sucked out by the pump 16. This is called the measurement phase. In this measurement phase all the air coming from the measurement box will flow through the sensor. This is resulting in the wanted compound ethanol as well the compounds that causes interferences or false unwanted signals. The signal is called Sm indicating the “Sensor measurement” that is created or representing the ethanol compound. This measurement phase is kept for y minutes, which can be adjusted, typically but not strictly necessary 6 minutes. At the end of this measurement phase the results of the measurement Sm are stored. Not strictly necessary but improving the quality, fit analysis and mathematical extrapolation routines are used to predict longer measurement times longer than y minutes. Due to the fact that there is no filter or catalyst installed in the suction line, ethanol is exposed to the sensor and Sm is together with the unwanted interferences (parameter Gas_Interference_m) part of the result. The relative humidity (RH) which is represented parameter RH_m and temperature due to isothermal stability is represented by parameter T_m are also not changed and have the same interference signal as the results measured during the zero phase.

After the measurement phase of y minutes, the system switches again to the zero phase at which valve 1 is switched on and valve 2 is switched off simultaneously. This process of alternating phases between zero phase and measurement phase is a continuous process.

After every measurement phase mathematical calculation can be done to calculate the ethanol concentration which is ultimately the result of the alternating phases. To calculate the exact ethanol concentration there are several options to improve the value by fitting data point from previous zero phases and measurements-phases as well extrapolation routines to predict longer zero-times x and longer measurement times y.

Due to the fact that certain types of molecules desorb to the surface and do not convert or partially convert in molecules that are desorbed as reactant, some of these molecules cover the active sites of the catalyst permanently in time. Especially ethyl acetate, water and acetaldehyde are able to permanently stick on the surface of the active surface. While covering the active sites the reactivity of the catalyst will be reduced. For example water which can be available in thousands of ppm can influence the catalytic activity in a negative way. This can be prevented by temporary desorption of the absorbed molecules. In a practical embodiment the active sites can be desorbed by heating the catalyst periodically. During this process the continuous zero phase and measurement phase is stopped.

The main calculation is based on:

Ethanol concentration=(Sm+Gas_Interference_m+RH_m+T_m)−(Sz+Gas|_Interferences_z+RH_z+T_z)

In this method:
Gas_Interference_m=Gas_Interference_z
RH_m=RH_z
T_m=T_z

Where Gas_Interference_m is removed against Gas_Interference_z

Where RH_m is removed against RH_z

Where T_m is removed against T_z

Resulting in the simplified formula:

Ethanol concentration=Sm−Sz

The measurements are performed in a specific order, which is shown in FIG. 5. The various steps of the method are shown in detail in FIGS. 6-11.

The measurement starts in step 100. The following step 101 represents a preflush phase in which the atmosphere in the test chamber 1, 2 is brought into communication with the atmosphere in the storage space 6, 7. Then the test chamber 1,2 is closed in step 102 and a pressure test is performed to check for leakage. Subsequently, a precleaning step 103 is performed by passing the atmosphere in the chamber through a filter. Then the actual measurements are made in step 104. And finally in the post-flush phase (step 105) the connection between the test chamber 1, 2 and the storage space 6, 7 is reestablished.

Before the start of the measurements, the system is on standby (FIG. 6, step 100A). In step 100B a check is made whether a start time has expired or a start command has been received. As long as this is not the case, the system remains on standby. When the result of the check is affirmative, the process proceeds to the preflush phase.

In the preflush phase the system or installation is preflushed for a predetermined period of x minutes, wherein x=60 is a typical value (FIG. 7, step 101A). Then the oxygen concentration is measured in step 101B.

The pressure test phase 102 consists of closing the measurement box and waiting for a minute (step 102A) and then determining if a pressure test is performed (step 102B). If not, the process continues with the preclean phase (step 103). Otherwise, the start pressure is determined (step 102C) and a check is made if the pressurizing time is exceeded (step 102D). If so, the process returns to start, but otherwise pressurization is performed for e.g. 30 seconds (step 102E). After the pressure has stabilized (step 102F), a check is made if the pressure setpoint has been reached (step 102G). If not, the process returns to step 102D, and n the affirmative, a wait time of e.g. 10 minutes starts (step 102H). Then the end pressure is measured (step 102I) and the pressure drop is calculated (step 102J). If the pressure drop is found to be within limits (step 102K), the process proceeds to preflush, and otherwise it returns to start.

In the next step 103 the system is precleaned for a predetermined period of x minutes, wherein x=150 is a typical value (FIG. 9).

The measurement process 104 consists of a determination if the number of measurements has been exceeded (104A). If not, a zero measurement is made, followed by an ethanol measurement, an O2/CO2 measurement and a calculation of ethanol change (steps 104B-E). If the number of measurements has been exceeded, a line fit is performed and FQ is calculated (steps 104F and 104G). Then the process continues to the postflush phase.

And in the final step 105 the system is postflushed for a predetermined period of x minutes, wherein x=60 is a typical value (FIG. 11).

The results of the measurements in the chamber can be presented in graphs as shown in FIGS. 12-14. These graphs allow the relationship between the measured amount of the metabolite and the measured amount of oxygen and/or carbon dioxide to be analyzed in a simple and straightforward manner.

In FIG. 12 the following comments apply:
1. The ethanol production (line 201) in the fruit flesh on the right y-axis 206 against the oxygen concentration on the x-axis 205 during the measurement.
2. The oxygen consumption (line 202) of the fruit flesh on the left y-axis 204 against the oxygen concentration on the x-axis 205 during the measurement.
3. The fermentation quotient (FQ) (line 203) on the left y-axis 204 against the oxygen concentration on the x-axis 205 during the measurement.
Note 1: In this graph the FQ is represented as the FQ x 3. This is done because the graph has practical limitation to two scales on the left and right y-axis.
Note 2: In this graph three fits are placed to give a better indication which line the spread points follow. The fit lines are not intended to represent a perfect mathematical fit.

For FIG. 13 the following comments apply:

1. The ethanol concentration (line 207) inside the fruit flesh on the right y-axis 212 against the time (x-axis 211).

2. The oxygen increase (line 208) caused by the fruit flesh on the left y-axis 210 against time (x-axis).

3. The fermentation quotient (FQ) (line 209) on the left y-axis against time (x-axis).

FIG. 14 shows both the ethanol production and the oxygen consumption as functions of the oxygen concentration. Line 214 is a fit for the measured points for the anaerobic ethanol production at low oxygen concentrations, while line 215 is a fit for the measurements for the aerobic ethanol production at higher oxygen concentrations. Values of ethanol production are shown on the left y-axis 216 and values for oxygen consumption (y the light points) on the right y-axis 218. The oxygen level is shown on the x-axis 217. This graph allows the crossover point between the anaerobic and aerobic ethanol production to be found at the intersection of lines 214 and 215. This crossover occurs at an oxygen concentration of approximately 0.3%.

The fermentation quotient is a good indicator of the start of fermentation, as can be seen by the fact that the curve representing the FQ rises a full day before the curve representing ethanol concentration.

Instead of a fermentation quotient, the relationship between ethanol production and oxygen consumption can be presented in a table which can be consulted to determine the steps to be taken. Such a table is represented below.

TABLE 1
Decision table to control oxygen in the storage with RQ based on RQ development across time

| | | | |
|---|---|---|---|
| Ethanol production | High ethanol | Small ethanol production | No/stable ethanol |
| O2 consumption | production | but increasing | prodcuction |
| | FQ > 0.005/day (Min. | FQ > 0.0005 < 0.005/ | FQ = 0.0 < 0.0005/ |
| | 4 days) | day (Min. duration 30 | day (Min. duration 30 |
| | For example 0.020 for | days) | days) |
| | Jonagold 2015 average | For example 0.002 for | For example 0.0 for |
| | 4 days | Junami 2015 average 69 | Jonagold 2015 average |
| | Or | days | 14 days |
| | same conversion in | Or | Or |
| | other units like | same conversion in other | same conversion in |
| | a.) ml/kg/h ethanol x | units like | other units like |
| | days | a.) ml/kg/h ethanol x | a.) ml/kg/h ethanol x |
| | b.) mg/100 g fruitflesh | days | days |
| | x days | b.) mg/100 g fruitflesh x | b.) mg/100 g fruitflesh |
| | | days | x days |
| Low | anaerobe fermentation | attention rot | attention |
| | caused by oxygen pull- | development | step down oxygen |
| | down | SF i.c.w. with AF | concentration |
| High | fermentation caused | attention rot | step down oxygen |
| | by rot eventually | development | concentration |
| | caused by oxygen | | |
| | pull-down | | |
| High - far above | much rot product | attention rot | step down oxygen |
| possible border of | | development | concentration |
| fermentation | | | |

TABLE 2
Development/measurement of RQ

| Ethanol | High ethanol | Small ethanol production | No/stable ethanol |
|---|---|---|---|
| production | production | but increasing | production |
| FQ | >=0.010 | <0.010 | <0.001 |

The method and installation described above and illustrated in the figures provide the following features and advantages.

A feature measurement method of ethanol, oxygen and FQ

A feature and surprising is that besides the absolute ethanol level also the production rate of ethanol and the consumption rate of oxygen is determined and is used to determine the decision to increase or decrease the oxygen level in the CA store where the product is stored. Current systems can technically not measure the ethanol production rate. This is also the same point with the destructive determination at which products are grinded in the laboratory and ethanol is determined. Even the grinding will produce amounts of ethanol and so give a deviation on the standard. Another issue is that during grinding some amount will be evaporate from the products, which also leads to a deviation in the determination of absolute values.

A feature is that periodically the O2 respiration rate/O2 decrease/oxygen consumption rate can be determined from a standardized weigth of fruit during the standardized measurement phase in the described standardized measuring box. This provides an extra marker possibility on development of anaerobe fermentation decision due to oxygen shortage and the quality of the fruit and the development of the quality during the fruit storage season.

Characteristic is that the production rate of ethanol, specific volatiles and the oxygen consumption rate of fruit can be compared between different storage seasons and different areas of production of the same type of fruit. By collecting this data and comparing this data better insight can be gained for creating the most optimum storage conditions for temperature oxygen, CO2, ethanol and the level of volatiles.

A feature and characteristic is the representing of the graphs that are created in FIG. 1 and FIG. 2.

A feature is the decision table described in table 1.

A feature is the combination of oxygen consumption combined with ethanol production.

A feature is the calculation of the FQ.

A feature and characteristic is the possibility to control the oxygen level in the CA storage by the described working method in such a way that the fermentation level, the ethanol production by the fruit is regulated on a chosen level. This level of ethanol production can be determined by comparing the FQ, ethanol production rates, oxygen consumption rates versus the development of the quality. The new working method provides a daily insight in the production rate of the sample of fruit and thus allowing to control either a zero tolerance for the production of ethanol or to enable a minimum of ethanol production on a level which contributes to the best preservation of the quality of the fruits.

A feature is the detection of possible rot or detoriation of fresh products by illness, fungi, mold or bacteria.

A feature and characteristic is the combination of a standardized measuring box, a standardized weight of sample a standardized measuring procedure, a standardised analysis, a standarized representation of the data, whereby the measured data, is processed by an analysing program which transfers the measured data in relative production rates and FQ and exposing this data for further analyse and basis for controlling the oxygen/CO level in CA stores.

Characteristic is that the gas analyser is able to measure the ethanol concentration in the ppb-range (Parts per billion range).

A feature and characteristics is that the during the measuring of the ethanol and oxygen values the production rates per time frame are calculated and analysed. Out of the production rate of ethanol which can evaporate/diffuse out of the fruit through the skin of the fruit in the surrounding air a logarithmic function is calculated and the ethanol production rate is determined as a result of this function after a certain time. Research and testing have resulted in the conclusion that the ethanol production during a selected time frame will stabilize on a certain level depending of the quantity of ethanol present in the individual apples of the sample. This stabilized level of ethanol production provides a good and reliable indication of the ethanol present in the fruit.

Because of the ability of measuring in an accurate way the increase of the ethanol in the measuring box and to create an logarithmic function it is possible to reduce the measuring time and to calculate what the ethanol production will be per time fraction after stabilizing of the ethanol evaporation out of the fruit into the air in the measuring box.

A universal system that monitors and determines with a common standardized method (by mean of automatic measurement and control) the fermentation point of the treated products in a test environment.

which has 1, 2 or more test chambers that are connected to an ethanol sensor and oxygen sensor.

which analyser is connected (not necessary) to an information/databases system that analyses the results.

Any living product which follows a process of respiration of sugars can be monitored in the test environment. This includes:
food like: vegetables, fruit, fish, meat, dairy products, cereals, fats, drinks, liquids.
Organic plant or animal tissues, rootstock, bulbs, (young) plants and flowers.

Production rate of ethanol (or the fermentation acceleration/deceleration) is monitored by means of the periodically measurement of ethanol. The measured values are analyzed and transformed by a computer program in a logarithmic function and the acceleration/deceleration speed of ethanol transfer from the fruit to the surrounding atmosphere in the standardized air environment of the measuring box is calculated.

The ethanol production is determined from a set of measurements in which a fit procedure is used to come to the production results. This mathematical method can be any mathematical fit procedure that reflects the practical situation.

With these mathematical fit procedures, measurement times can be optimized to shorter measurement times. A feature is that the fit procedures are determined to improve the measurements and calculations for determination of the ethanol production rate.

A feature is that this ethanol measurement system is based on real physical units that are measured and calculated and have a direct relation with the volatiles and/or ethanol that is evaporated from the products.

Units of the measurement-results are in produced ethanol volume/mass product/time period and all other derivates like production rate of ethanol concentration, mass product/volume ethanol production or derivations like concentration of ppb/kg product, ml/kg product or vice versa.

Test measurement chambers and ethanol/oxygen analyser (sensors) can be used in laboratory conditions as well mounted on the storage which results in the same environmental conditions for the test chambers in relation to the storage.

A feature is that next to the measurement of the ethanol production rate in the test chamber also a measurement can be done of ethanol and other volatiles in the CA storage in storage of absolute numbers as well of and volatile and ethanol production rates. A comparison of these 2 values can be made and a mathematical relation can be determined per product.

Innovatie and characteristic A feature is that when a measuring box test chamber is integrated mounted onto in a CA store main storage, at the start of the measurement procedure the present CA conditions in the CA stores are equal to the CA condition in the measurement box. During the interval times of measurement procedures in the measuring box the same climate conditions as in the CA storage are present in the measuring box. For this reason the fermentation level of the fruit in the measurement box reflex the present situation for the main volume of the fruit in the CA storage very well.

for the determination of the ethanol production rate the start conditions are the same in the test chamber as well in the storage. This is enabled done by an room valve connection that can be opened or closed or a valve and/or pump(s) that transports gas from the CA storage main storage to the test chambers. This exchange of gases is done periodically. The CA storage main storage is used as a reference condition in the test chamber. By exchanging this gas conditions the analysed products meets as close as possible the real products in the main storage.

A feature and characteristic A feature is the standardized sequence of combination of phases during the so called measurement procedure. The phase which that are used and described, (not strictly in this order) compromises;
Flush phase
O2 measurement determination
Pressure test phase
Filtering Cleaning phase for creating a start position for measurement of ethanol, volatile and the respiration level by means of oxygen measurement
Ethanol measurement phase including analyzing and calculation the measured production level of ethanol per weigth unit of sample per time fraction.
Flush phase

A feature is that during the measurement phase the composition of oxygen and carbon dioxide hardly changes. This unique feature is important to maintain the conditions that determine the fermentation. There are no disturbing conditions that influence the fermentation rate during measurement. No additional nitrogen or oxygen supply is needed to determine the ethanol production rate.

A feature is that the system with an additional oxygen and/or nitrogen supply system can determine the ethanol production rate measurements (in other words fermentation determination) in a save way in the test chamber without exposure of the main mass production storage to harmful values. After the determination of the fermentation point in the test chamber the oxygen of the main storage can be adjusted manually or automatically to optimize the storage conditions.

A feature is that the sampled products are analysed in a non-destructive way. All other current laboratory ethanol measurements in fruit are done by milling the fruit to pulp.

A feature is that the production rate of ethanol can be determined and is used to determine the decision to increase or decrease the oxygen in the storage where the main product is stored. The conditions are as close by as possible without any other artefacts or influences.

A feature is that the determination of ethanol is done by fully automated control.

A feature is that over time the system generated a trend line of the measurement data, in which can be seen if the product runs in a more or less stable fermentation state.

Characteristic is that a world-standard is introduced for the determination of the FQ derived from the ethanol production and the oxygen consumption of a product that uses physical units in production rate ethanol gas in volume/mass/time of analysed product.

Also characteristic is that the application of determination of the ethanol production in test chambers leads to an improved storage of the products and has the advantage that there is no need of additional chemicals (DPA or ethylene blocker) and that the storage of products can be done in a chemical-free way.

Characteristic is that the process contains a cleaning phase by means of a filter whatever principle is used in which the gas composition is refined from volatile organic compounds and aromatic compounds. All unwanted compounds are removed in this phase.

Characteristic is that during the cleaning phase of the process, the oxygen and nitrogen conditions in the test chamber remain the same conditions. Measurement results will not be influenced by changed conditions during the complete determination process.

Characteristic is to run the process of volatile determination can be extended to a longer period so that ethanol build up in the product (buffered) can be evaporated over time and measured in the process. Fermentation control by ethanol production can thus be determined across longer periods.

Characteristic is that with the determination of the volatiles or ethanol production rate also the moment of change from increasing rate to decreasing rate or vice-versa can be determined.

Characteristic is that with the addition of external nitrogen or oxygen in the test chamber during the process a faster or slower process in time of the fermentation point can be reached.

Characteristic is that the mounting of the analyser in combination with the heated manifold will prevent condensation and by this loss of ethanol gas compound due to dissolve of ethanol in condensed water vapour. Condensation prevention by this method is 1 of the several methods that are possible.

Characteristic is that the sampled product easily can be inspected and can be accessed from outside of the storage by removing the lid or cover. There is no direct risk of safety due to exposure of low oxygen emission out of the test chamber.

Characteristic is the test chamber can be mounted as well inside the storages, on the ceiling of the storage or on the front of the storage, as well outside the storage or not strictly direct connected to the storage, (for example) in a laboratory. The test chambers can be used in a multi-purpose way. This test chamber(s) has some Characteristic features and has the following Characteristic properties:
In case of mounting the test chamber connected directly to the storage: Goal is that the test chamber meets the climate conditions as close as possible to the storage to storage representative products in the test chamber under the closest or same conditions as in relation to the storage.
In case of mounting the test chamber not directly with a storage: Goal is to achieve a climate condition that is as close as possible to the intended setpoints to storage representative products in the test chamber under the closest or same conditions as in relation to the setpoints.
The test chamber can be equipped with additional cooling or heating equipment and can also been equipped with additional nitrogen, oxygen, ethylene, ethanol or other gas feed lines to change the test chamber climate—and gas conditions.
The test chamber is designed in such way that it can be used for use inside storage (mostly a fruit storage under CA (Controlled Atmosphere conditions) but not strictly necessary a fruit storage), or in the ceiling of the storage or in the front of the storage.
The test chamber is highly isolated for possible unwanted heat transport from outside the storage to the inside of the measurement box.
The test chamber has a transparent lid or cover which is necessary for the visual inspection of the sampled product.
The transparent lid or cover is made of highly robust material (for example safety glass or highly shock resistant transparent safety glass) to protect people and animals from suddenly unexpected and unwanted ingress by means of for example an unexpected and unwanted fall or collision.
The transparent lid or cover is a double or triple layer material lid. The space in between the layers can be filled with a non-condensation highly isolated gas under ambient pressure like nitrogen or dry air to realize an ideal isolation of stationary air and realize no condensation in or around the lid- or cover material.
The space in between the lid- or cover material is complete air tightened.
The lid or cover itself closes complete airtight to the test chamber with a seal.
The test chamber has 1 or more connection(s) that can be opened or closed to the storage at which gas from the storage to the test chamber or vice-versa can be transferred. This connection can automatically been opened or closed by means of a valve, a bellow or any other device that can be opened or closed.
The test chamber is made of food-safe material. That means that the material that is used does not create oxidation, create unwanted particles that affects or contaminate food and does not influence the measurements or the product that is stored inside or outside the measurement box.
The test chamber is built in such a way that water condensation is minimized or complete condensation-free. If unexpected and unwanted water condensation arises, this water will be drained by 1 or several openings that are in the test chamber that can be automatically opened and closed.
The size of the test chamber can be any size as long as the size is represent for the product or sample size that is inside the measurement box.

Characteristic is the analyser that is connected to the test chamber(s). This analyser has some Characteristic features and has the following properties:
The analyser is connected with one test chamber or more test chambers.
The analyser is connected directly with the test chamber (but not strictly necessary) to prevent possible water condensation around or inside the sampling lines.
The analyser has a heated manifold which is directly but not strictly necessary connected to the test chamber. In case of no direct connection line to the test chamber, the analyser is connected by means of a heated extension tube.
The analyser analyses: Ethanol, oxygen, ethylene and carbon dioxide. Carbon dioxide not strictly necessary. Ethanol strictly necessary.
The analyser calculates the production rates of the measured gasses like ethanol, oxygen, ethylene and carbon dioxide that are generated inside the test chamber during the measurement phase.
The analyser analyses its ethanol concentration values on a level of ppb (parts per billion) strictly necessary to determine the production rate of the product inside the test chamber.
The analyser generate data of the calculated vales and production rates and is connected to a to a central control computer, climate control system or storage computer or any other computer which interprets data from the analyser and controls the oxygen level(s) of the storage(s).
The analyser send data to the central control computer and determines indirect the oxygen levels by means of control of the oxygen level inside the storage by actuators that controls the oxygen level(s) inside the storage(s).

Although the invention has been described by reference to embodiments thereof, it is not limited thereto but is defined solely by the following claims.

1. A method for controlling an atmosphere in a space which is at least partially filled with agricultural or horticultural products, comprising the steps of:
a) measuring an amount of at least one metabolite such as acetaldehyde, ethyl acetate and/or ethanol produced by the products;
b) measuring at least one of:
i) an amount of oxygen absorbed by the products; and
ii) an amount of carbon dioxide produced by the products;
c) determining a relationship between the measured amount of the metabolite and the measured amount of oxygen and/or carbon dioxide;
d) analyzing the determined relationship to detect a potential onset of fermentation in the products; and
e) selectively adjusting a level of at least one component of the atmosphere in the space on the basis of the analysis.

2. The method of claim 1, wherein the analysis of the determined relationship further serves to detect a potential onset of rot or decay of the products.

3. The method of claim 1 or 2, wherein the relationship is determined from a lookup table.

4. The method of claim 1 or 2, wherein the relationship is determined by dividing the measured amount of the metabolite by the measured amount of oxygen or the measured amount of carbon dioxide to establish a fermentation quotient.

5. The method of claim 4, wherein the level of the at least one atmospheric component is adjusted when the fermentation quotient exceeds a predetermined threshold.

6. The method of any one of the preceding claims, wherein a sample is taken from the products in the space, and wherein the measured amount of the metabolite and the measured amount of oxygen and/or carbon dioxide represents the metabolite produced by the products in the sample and oxygen absorbed or carbon dioxide produced by the sample products, respectively.

7. The method of claim 6, wherein the sample products are isolated from the rest of the products in the space and wherein an atmosphere surrounding the isolated sample products is stripped of other volatiles at least before the amount of the metabolite is measured.

8. The method of claim 7, wherein the atmosphere surrounding the isolated sample products is filtered before the amount of the metabolite is measured.

9. The method of claim 7 or 8, wherein the atmosphere surrounding the isolated sample products is first brought into communication with the atmosphere in the space, is then isolated from the atmosphere in the space, is subsequently pressurized to test for potential leakage between the isolated atmosphere and the atmosphere in the space, and is then stripped of the other volatiles before measurement of the amount of the metabolite, and wherein after the measurement the atmosphere surrounding the isolated sample products is again brought into communication with the atmosphere in the space.

10. The method of any one of the preceding claims, wherein the actual amount of the metabolite and the actual amount of oxygen and/or carbon dioxide are repeatedly measured and production rates of the metabolite and oxygen and/or carbon dioxide, respectively, are determined on the basis of successive measurements.

11. The method of any one of the preceding claims, wherein the metabolite is ethanol and the amount of the metabolite is measured by an ethanol sensor which is calibrated before each measurement.

12. The method of claim 11, wherein the ethanol sensor is calibrated by performing a measurement of a part of the atmosphere that is devoid of ethanol.

13. The method of any one of the preceding claims, wherein step b-ii) comprises measuring both an amount of carbon dioxide produced by the isolated products and an amount of carbon dioxide produced by the products in the space, and wherein the measured amount of carbon dioxide in the space is analyzed independently to detect a potential onset of fermentation and/or rot or decay of the products.

14. An installation for controlling an atmosphere in a space which is at least partially filled with agricultural or horticultural products, comprising:
a) first measuring means arranged for measuring an amount of at least one metabolite such as acetaldehyde, ethyl acetate and/or ethanol produced by the products;
b) second measuring means arranged for measuring at least one of:
i) an amount of oxygen absorbed by the products; and
ii) an amount of carbon dioxide produced by the products;
c) determining means arranged for determining a relationship between the measured amount of the metabolite and the measured amount of oxygen and/or carbon dioxide;
d) analyzing means arranged for analyzing the determined relationship to detect a potential onset of fermentation in the products; and
e) adjustment means arranged for selectively adjusting a level of at least one component of the atmosphere in the space on the basis of the analysis.

15. The installation of claim 14, wherein the analyzing means are further arranged to detect a potential onset of rot or decay of the products.

16. The installation of claim 14 or 15, wherein the determining means comprise at least one lookup table.

17. The installation of claim 14 or 15, wherein the determining means are arranged to determine the relationship by dividing the measured amount of the metabolite by the measured amount of oxygen or the measured amount of carbon dioxide to establish a fermentation quotient.

18. The installation of claim 17, wherein the adjustment means are arranged to adjust the level of the at least one atmospheric component when the fermentation quotient exceeds a predetermined threshold.

19. The installation of any one of claims 14-18, further comprising sampling means arranged to accommodate a sample taken from the products in the space, wherein the first and second measuring means are arranged to measure amounts of the metabolite, oxygen and/or carbon dioxide which are representative of the products accommodated in the sampling means.

20. The installation of claim 19, wherein the sampling means comprise at least one chamber including isolation means for selectively isolating the chamber from the space, further comprising stripping means arranged for stripping the atmosphere surrounding the isolated sample products of volatiles.

21. The installation of claim 20, wherein the stripping means comprise at least one filter connected in a closed circuit with an interior of the at least one chamber.

22. The installation of claim 20 or 21, wherein the isolation means comprise at least one inflatable seal arranged between a wall of the chamber and a surrounding edge.

23. The installation of any one of claims 14-22, wherein the first measuring means are arranged for repeatedly measuring the actual amount of the metabolite and for determining a metabolite production rate on the basis of successive measurements, and wherein the second measuring means are arranged for repeatedly measuring the actual amount of oxygen and/or carbon dioxide and for determining an oxygen and/or carbon dioxide production rate on the basis of successive measurements.

24. The installation of any one of claims 14-23, wherein the first measuring means are arranged for measuring ethanol and comprise at least one ethanol sensor which is arranged to be calibrated before each measurement.

25. The installation of claim 24, further comprising a catalytic ethanol converter which is selectively connectable with the at least one ethanol sensor.

26. The installation of claim 25, wherein the catalytic ethanol converter is an ambient temperature platinum loaded converter.

27. The installation of any one of claims 20-26, wherein the at least one chamber is both gastight and thermally isolated from the space.

28. The installation of any one of claims 20-27, wherein at least one wall of the at least one chamber is at least partially transparent.

29. The installation of any one of claims 20-28, further comprising pressurizing means cooperating with the isolation means for pressurizing the chamber to test for potential leakage between the isolated chamber and the space.

30. The installation of any one of claims 20-29, further comprising third measuring means which are independent of the second measuring means and which are connected to the analyzing means, the third measuring means being arranged for measuring an amount of carbon dioxide produced by the products in the space and the analyzing means further being arranged to detect a potential onset of fermentation and/or rot or decay of the products on the basis of the measured amount of carbon dioxide.

31. A selectively isolatable chamber for use in the installation of any one of claims 20-30.

32. An ethanol sensor for use in the installation of any one of claims 24-30.
